(19) United States
(12) Patent Application Publication
(10) Pub. No.: US 2002/0003340 A1
(43) Pub. Date: Jan. 10, 2002

(54) Load platform step construction

(75) Inventor: Kurt Hallquist, Downingtown, PA (US)

Correspondence Address: William Squire, Esq., c/o Carella, Byrne, Bain, Gilfillan, Cecchi,, Stewart & Olstein, 6 Becker Farm Road, Roseland, NJ, 07068, US

(73) Assignee: Morgan Corporation

(21) Appl. No.: 09/874,075

(22) Filed: Jun. 5, 2001

Related U.S. Application Data
(60) Provisional application No. 60/216,389, filed on Jul. 6, 2000.

(51) Int. Cl. B60R 3/00

(52) U.S. Cl. 280/163

(57) ABSTRACT

A truck with a cargo carrying body has a rear load platform with a stair well opening. A stair subassembly includes a plurality of steps secured thereto in the stair well and rotatably secured to the load platform. In the closed retracted stored state of the subassembly a platform member attached thereto forms a continuous platform surface with the rear load platform and supports persons on the platform as a single platform. When the stair subassembly is rotated to the deployed state, several stairs are exposed in the stair well, one fixed and others rotating with the subassembly to provide easy access to the load platform without obstruction to or on the load platform by elements of the subassembly.

This invention relates to truck rear loading platforms, and more particularly, to steps for accessing personnel to the platform from ground level.

Many trucks have rear loading platforms adjacent to the rear loading doors. These platforms are relatively narrow. Typical steps which are relatively small are provided on the rear sides of the platform. These steps may be in the form of indentations in a rear platform side wall or rungs secured to the truck body frame at the rear. These steps are difficult to navigate especially during loading or unloading the vehicle. Because the platform is relatively narrow, there is insufficient room in the metes and bounds area of the platform to locate steps because the amount of area for loading purposes is limited.

U.S. Pat. No. 255,327 discloses a step for vehicles. This discloses a complex mechanism for displacing the step to an acquiescent stored position. However, this patent issued in 1882 and the disclosed structure is not readily adaptable for modern trucks. The quiescent stored position of the step would interfere with the loading platform region of a truck.

U.S. Pat. No. 578,332 shows a vehicle tail gate that also serves as a step. This structure is applicable to vehicles with tail gates and not to enclosed trucks with rear platforms.

U.S. Pat. No. 2,546,626 discloses a vestibule trap door arrangement in which a trap door is hinged to a platform and is locked in place with a brace to expose a stair well. The trap door when open to expose the stairs is upright and would interfere with the use of a truck rear platform during loading. This arrangement is for use with passenger rail cars.

U.S. Pat. No. 2,481,230 discloses a trailer having a deployed state and a collapsed state. In the deployed state a stair is shown that rotates into the collapsed state with the trailer. This stair when collapsed forms part of the collapsed trailer exterior contour not related to loading platforms of trucks. This disclosure does not disclose the above problem with rear loading truck platforms.

U.S. Pat. No. 5,868,412 discloses a stairway for flatbed vehicles. The stairway is in the bed of the vehicle and is covered by a lid that rotates from an open state to a closed state. In the open state the cover overlies the bed and stair. In a second embodiment, the truck rear door is aligned over the cover and stair. In either case, the open cover interferes with use of the truck bed during loading and unloading.

Still other stair arrangements for vehicles are disclosed in U.S. Pat. Nos. 3,580,613, 4,198,070, 5,505,476, 5,584,493, 5,695,207 and 5,816,638 and in French Patent 1.383.843. Some of these disclose stairs that are covered with a lid or the stair is retracted from a deployed position to a retracted position, and are not disclosed as useful with truck rear loading platforms

The present invention is a recognition of a need for a stable platform and step arrangement wherein the full use and integrity of the loading platform is available at all times. The loading platform includes a portion which has deployed and stored states such as to form an access stair to the loading platform that is relatively central the platform, convenient to use for loading and unloading cargo to and from the platform and yet does not interfere in any way with the use of the platform whether or not the step is in use in the deployed state.

A vehicle step construction for a cargo vehicle loading platform according to an aspect of the present invention comprises a vehicle loading platform defining a platform surface having an opening therethrough and arranged to be secured to the cargo vehicle and a stair structure having deployed and stored states aligned with the opening and rotatably secured to the platform, the stair structure including at least one step for accessing the platform through the opening in the deployed state and a platform member for rotation with and secured to the at least one stair so that the platform member encloses the opening in the stored state to form a continuation of and a portion of the platform surface.

In a further aspect, the stair construction comprises a frame pivotally secured to the platform aligned with the opening for rotation from and to the deployed and stored states, the at least one step being secured to the frame, and means for securing the platform member to the frame.

In a further aspect, the at least one step includes a first step secured to the platform member and a second step secured to the frame in spaced relation to the first step, the first and second steps for rotating with the frame.

Preferably a further step is fixedly secured to the loading platform in the opening and arranged to form a step arrangement with the at least one step.

In addition, the platform member preferably includes latch means secured thereto for releasably latching the stored stair structure to the platform.

In a further aspect, the latch means includes a movable handle including means for recessing the handle in the platform surface and a latch responsive to the displacement of the handle for releasing the latched stair structure.

In a further aspect, the frame comprises first and second spaced gusset members and pivot means for pivotally securing the gusset members to the loading platform, the at least one step being secured to and extending to and between the gusset members.

Preferably, the gusset members are flat steel plates, and the at least one step is stamped sheet metal.

In a further aspect, the latch means are coupled to the stair structure and platform for releasably latching the stair structure in the stored state.

### BRIEF DESCRIPTION OF THE DRAWING

FIG. 1 is a perspective view of a truck vehicle rear loading platform with a deployed step arrangement according to the present invention;

FIG. 2 is a side elevation sectional view of the rotating frame and step configuration of the embodiment of FIG. 1;

FIG. 3 is a front elevation view of the embodiment of FIG. 1;

FIG. 4 is a perspective view of the platform of FIG. 1 with the step arrangement in the stored state; and

FIG. 5 is an isometric view of the handle portion of the latch device of the structure of FIG. 1.

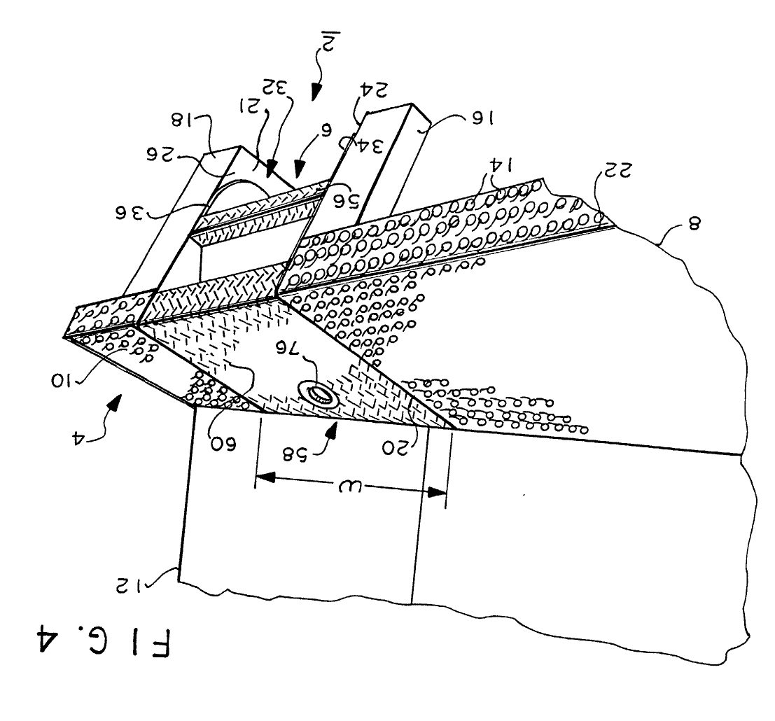

In FIGS. 1, 3 and 4, stair assembly 2 comprises by way of example a truck rear loading platform 4 and stair construction 6. The platform 4 includes a platform structure 8 formed of stamped sheet steel having a platform loading surface 10. The platform 4 extends rearwardly from a cargo receiving chamber formed by truck body 12, FIG. 4. The remainder of the truck is not shown. The platform 4 may be connected as the floor bed of a body 12 fixed to a truck cab or part of a truck trailer bed. While the platform 4 is by way of example described as a rear platform, its orientation with respect to the truck body 12 may be varied to a side of the body as desired. Also, the platform 4 may be part of a flat bed truck body either fixed to a cab or associated with a flat bed trailer. While the platform 4 is also illustrated as use with a vehicle, such a platform may be implemented in non-vehicular environments. The platform 4 may have a roughened surface 10 formed with an array of projections 14 to minimize slipping as known in this art.

Two spaced flanges 15 and 17 depend from the outer rear peripheral edges of the platform structure 8 and may be formed one piece and integral with the surface portion of the structure 8 which may have other flanges also formed one piece therewith. A forward flange 19, FIG. 1, formed one piece with the structure 8, depends from the forward edge of the surface 10 and is attached to the truck frame by elements such as beams and welds or bolts (not shown). Platform support beams (not shown) for supporting the surface 10 portion of the platform structure 8 may also be used according to a given implementation. The term forward as used herein refers to the front of the associated vehicle and the term rear refers to the rear of the vehicle.

Two steel beam posts 16 and 18 depend from and are secured to the platform structure 8, e.g., preferably welding, in spaced relation. The posts 16 and 18 are hollow and may be square or rectangular in cross section. The platform structure 8 has a through opening 20 therein. The opening 20 extends from rear edge 22 forward to the truck cargo body 12, FIG. 4. The opening 20 has a width w sufficient and a length in the rear-forward direction to form a stair well 21 for a person, for example, 2-3 feet in width w. The platform 4 has a rear-forward length of about 2-4 feet. A steel plate 24 is secured to post 16 and a steel plate 26 is secured to post 18 in the opening 20 forming the width of the well 21. Plates 24 and 26 are preferably rectangular and depend from the platform structure 8 for the length of the posts 16 and 18. The plates may be welded to the platform structure 8 and to the posts and other structure (not shown). The plates 24 and 26 form the interior of stair well 21 aligned with the opening 20 at the top of the stair well. The platform structure 8 has a depending flange 28 in the opening 20 at the forward edge of the opening 20. This flange 28 and its associated platform surface may be aligned beneath the closed cargo rear doors 12′ and 12″, FIG. 4, and therefore is not seen in this figure. In the alternative, the doors may be further forward with a portion of the platform 4 adjacent to the opening 20 extending rearward of the doors to the opening 20.

A one piece steel plate U-shaped step 30 is attached to and between the plates 24 and 26 either by bolts (not shown) or welds. The step 30 is placed vertically below the plane of the platform surface 10 a distance at a conventional stair riser spacing.

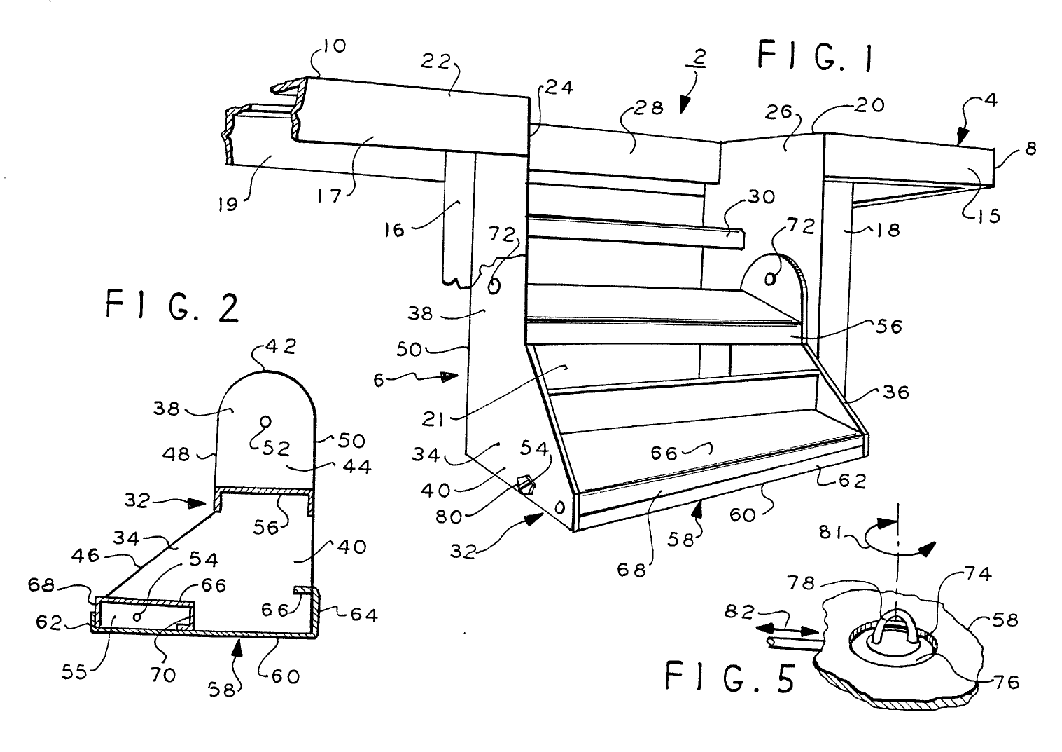

Stair construction 6 includes stair subassembly 32. The subassembly 32 includes two side gusset members 34 and 36. In FIG. 2, representative gusset member 34 comprises a steel plate including an upper section 38 and a lower section 40. Upper section 38 has a semi-circular edge 42 and a rectangular portion 44. The lower section 40 has a rear edge 46 that is inclined toward the adjacent edge 48 of the upper section. The upper and lower sections have a coextensive front edge 50. A bearing through opening 52 is formed in the upper section 38. The gusset member 36 is identical to the member 34 thus far described. A latch opening 54 is also formed in the member 34 only.

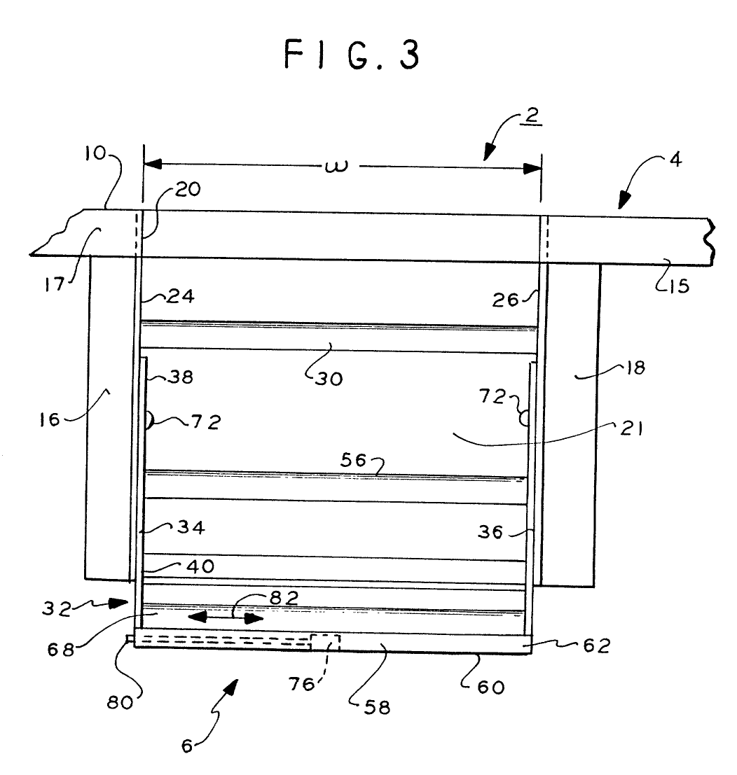

A U-shaped one pieced stamp sheet steel step 56 is welded at its ends to and between the gusset members 34 and 36. A formed platform member 58 is welded to and between the gusset members 34 and 36. The platform member 58 has a surface 60 that is formed with projections the same as on the surface 10 of the platform structure 8. In FIG. 2, the member 58 has a flange 62 at the edge 46 of the gusset member 34 (and 36) and a flange 64 at the opposite edge. The flange 62 is at the rear and the flange 64 is at the front of the stair well 21 in the deployed state of the subassembly 32, FIGS. 1 and 3. In the stored state of the subassembly 32, FIG. 4, the surface 60 is coextensive with the platform surface 10 and forms a continuation and portion of the platform surface in the opening 20. The opening 20 is substantially covered and the well 21 is enclosed by the platform member 58.

In FIG. 2, a shaped one piece formed steel plate forms step 66 and is welded to the flange 62 and to and between the gusset members 34 and 36. The step 66 has forward and rear flanges 68 and 70, respectively (in the orientation of FIG. 2) and lips that bend inwardly from these flanges and abut the platform member 58. Step 66 forms the lowermost step of the subassembly 32 in the deployed state of FIGS. 1 and 3. The opening 54, FIG. 2, is in communication with the chamber 55 formed by step 66, platform 58 and the gusset members.

The gusset members 36 and 38, FIGS. 1 and 3, are respectively pivotally attached to the corresponding stair well 21 plates 24 and 26 at bearing openings 52 by bolt-bushing and nut assemblies 72. Other bearing arrangements may be provided in the alternative for pivotally securing the stair subassembly 32 to the plates 24 and 26 and thus to the platform structure 8.

In FIG. 5, the platform member 58 is formed with an opening 74. A latch mechanism 76 is secured to the member 58 in the chamber 55 (FIG. 2). The mechanism 76 includes a loop handle 78 which is pivotally secured so it may extend upright as in FIG. 5 or folded over flat so it is recessed beneath the surface 60 of the platform member 58, FIG. 4. A latch 80, which is an elongated rod attached to mechanism 76 and operated thereby, passes through the opening 54, FIG. 2. Rotation of the handle 78 in directions 81. FIG. 5, reciprocates the latch 80 in directions 82. A latch receptacle (not shown) is in plate 24 at the top of the well 21 adjacent to the opening 20 receives the latch 80 as in conventional door latches which is resiliently secured for displacement in directions 82. The latch 80 normally engages the receptacle when the subassembly is rotated to the stored retracted state of FIG. 4. This latch engagement secures the subassembly in this position.

In operation, in FIG. 4, the handle of the latch mechanism 76 of the stored subassembly 32 forming the stair structure is lifted to the position of FIG. 5 and rotated to release the latch 80 (FIG. 3). The subassembly 32 is then manually grasped and rotated about the journal-bearing formed by the assembly 72. The subassembly is fully rotated to the position of FIGS. 1 and 3. In this deployed state, the platform member 58 is beneath the stair subassembly 32 and the steps 30 (fixed), 56 and 66 (rotatable) are aligned in the stair well 21 to provide easy access to the platform 4 without obstruction on the platform by any of the elements of the subassembly 32. A person may load the truck via the steps with ease and safely due to the wide access of the stairs to the platform.

When the stair is not in use, it is rotated to the retracted stored state of FIG. 4 where it automatically latches in position when placed in its full stored position. The platform member 58 surface 60 is now coplanar with the surface 10 of the remainder of the platform 4 to form a safe continuous load platform for a person without obstruction and with sufficient strength to support a person and any load carried by the person. Prior art stairs with rotating lids interfere with the use of such a platform and are not desirable for this implementation.

It will occur to those of ordinary skill that various modifications may be made to the disclosed embodiments. The scope of the invention is intended to be defined by the appended claims.

What is claimed is:

1. A vehicle step construction for a cargo vehicle loading platform comprising:
a vehicle loading platform defining a platform surface having an opening therethrough and arranged to be secured to the cargo vehicle; and
a stair structure having deployed and stored states aligned with the opening and rotatably secured to the platform, the stair structure including at least one step for accessing the platform through the opening in the deployed state and a platform member for rotation with and secured to the at least one stair so that the platform member encloses the opening in the stored state to form a continuation of and a portion of the platform surface.

2. The structure of claim 1 wherein the stair construction comprises a frame pivotally secured to the platform aligned with the opening for rotation from and to the deployed and stored states, the at least one step being secured to the frame, and means for securing the platform member to the frame.

3. The construction of claim 2 wherein the at least one step includes a first step secured to the platform member and a second step secured to the frame in spaced relation to the first step, the first and second steps for rotating with the frame.

4. The construction of claim 1 including a further step fixedly secured to the loading platform in said opening and arranged to form a step arrangement with the at least one step.

5. The construction of claim 1 wherein the platform member includes latch means secured thereto for releasably latching the stair structure to the platform.

6. The construction of claim 5 wherein the latch means includes a movable handle including means for recessing the handle in the platform surface and a latch responsive to the displacement of the handle for releasing the latched stair structure.

7. The construction of claim 2 wherein the frame comprises first and second spaced gusset members and pivot means for pivotally securing the gusset members to the loading platform, the at least one step being secured to and extending to and between the gusset members.

8. The construction of claim 7 wherein the gusset members are flat steel plates, and the at least one step is stamped sheet metal.

9. The construction of claim 1 including latch means coupled to the stair structure and platform for releasably latching the stair structure in the stored state.
